(19) United States
(12) Patent Application Publication
(10) Pub. No.: US 2012/0006915 A1
(43) Pub. Date: Jan. 12, 2012

(54) ELECTROSTATIC ATOMIZATION APPARATUS

(75) Inventors: Hiroshi Suda, Takatsuki (JP); Junpei Ohe, Hirakata (JP); Takafumi Omori, Hikone (JP); Takayuki Nakada, Hikone (JP)

(73) Assignee: Panasonic Electric Works Co., LTD., Osaka (JP)

(21) Appl. No.: 13/148,906

(22) PCT Filed: Mar. 25, 2010
(86) PCT No.: PCT/JP2010/055981

§ 371 Date: Aug. 10, 2011

(30) Foreign Application Priority Data
Mar. 26, 2009 (JP) 2009-077685

(51) Int. Cl. B05B 5/00

(52) U.S. Cl. 239/690

(57) ABSTRACT

An electrostatic atomization apparatus (4) includes a discharge electrode (1) and a liquid supplying device (2), which supplies liquid to the discharge electrode. A high voltage application device (3) that applies high voltage to the discharge electrode and performs electrostatic atomization on the liquid supplied to the discharge electrode. A discharge optimization unit electrically coupled to the high voltage application device so that potential at the discharge electrode is such that electrostatic atomization is performed in an acyclic manner without stopping discharging.

### TECHNICAL FIELD

The present invention relates to an electrostatic atomization apparatus that performs electrostatic atomization to generate charged micro-particle water of nanometer size and supplies the micro-particle water to an atomization area.

### BACKGROUND ART

An electrostatic atomization apparatus cools an atomization electrode and condenses the moisture in air to supply the atomization electrode with condensed water. A high voltage power supply circuit applies high voltage to the water supplied to the atomization electrode. This causes electrostatic atomization that generates charged micro-particle water. Japanese Laid-Open Patent Publication No. 2005-131549 describes such an electrostatic atomization apparatus.

The electrostatic atomization apparatus applies an initiation voltage to the atomization electrode to start electrostatic atomization. When voltage is applied to the atomization electrode, Coulomb force acts on the water formed at a distal portion of the atomization electrode. As a result, the surface level of the water locally rises into a conical shape (Taylor cone). The concentration of charge at a distal portion of the Taylor cone increases the electric field intensity at this portion. This increases the Coulomb force produced at the distal portion so that the Taylor cone further grows. When the charge density at the distal portion of the Taylor cone increases, the water at the distal portion of the Taylor cone receives energy exceeding the surface tension (repulsive force of the high density charge). This fragments and scatters the water (Rayleigh fission) at the distal portion of the Taylor cone and generates charged micro-particle water of nanometer size.

When electrostatic atomization occurs, noise is produced when the repulsive force of the high density charge fragments and scatters the water at the distal portion of the Taylor cone. When the water is fragmented and scattered, variations in the frequency of the Trichel pulse is small, and electrostatic atomization occurs in a cyclic manner. As a result, noise at a specific frequency becomes outstanding and thereby produces uncomfortable noise.

### SUMMARY OF THE INVENTION

The present invention provides an electrostatic atomization apparatus that properly generates charged micro-particle water, while reducing uncomfortable noise.

The present invention further provides an electrostatic atomization apparatus that properly generates charged micro-particle water with small power consumption, while reducing uncomfortable noise.

One aspect of the present invention is an electrostatic atomization apparatus including a discharge electrode. A liquid supplying device supplies liquid to the discharge electrode. A high voltage application device applies high voltage to the discharge electrode so that the liquid supplied to the discharge electrode undergoes electrostatic atomization. A discharge optimization unit is electrically coupled to the high voltage application device so that the potential at the discharge electrode is such that the electrostatic atomization occurs in an acyclic manner without suspending discharging. This structure reduces noise at a specific frequency and decreases noise that is uncomfortable to a person. Further, the suspension of discharging is avoided. This properly generates charged micro-particle water.

Preferably, the discharge optimization unit includes a resistor coupled in series to the high voltage application device. The resistor has a resistance value of 40 MΩ to 150 MΩ so that a Trichel pulse frequency variation is 0.17 kHz or greater when the electrostatic atomization occurs. This structure reduces noise at a specific frequency and decreases noise that is uncomfortable to a person. Further, the charging time is set at a suitable value. This continuously generates charged micro-particle water with lower power consumption.

Preferably, the discharge optimization unit is coupled in series between the discharge electrode and the high voltage application device. This allows for discharging to be performed with a simple structure.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing an electrostatic atomization apparatus according to the present invention;

FIG. 2 is a graph showing the relationship of the resistance value and the peak current value;

FIG. 3 is a graph showing the relationship of the resistance value and the frequency (Trichel pulse frequency);

FIG. 4 is a graph showing the relationship of the resistance value and the frequency variation (Trichel pulse frequency variation);

FIG. 5A is a graph showing the discharge current waveform for the resistance value of sample 1 in table 1;

FIG. 5B is a graph showing the discharge current waveform for the resistance value of sample 3 in table 1;

FIG. 6 is a graph showing the frequency characteristics of acoustic pressure for the resistance values of samples 1 and 3 in table 1;

FIG. 7A is a graph showing changes in the voltage at the discharge electrode when a 75 MΩ resistor is coupled; and

FIG. 7B is a graph showing changes in the voltage at the discharge electrode when a 170 MΩ resistor is coupled.

### DETAILED DESCRIPTION OF THE EMBODIMENTS

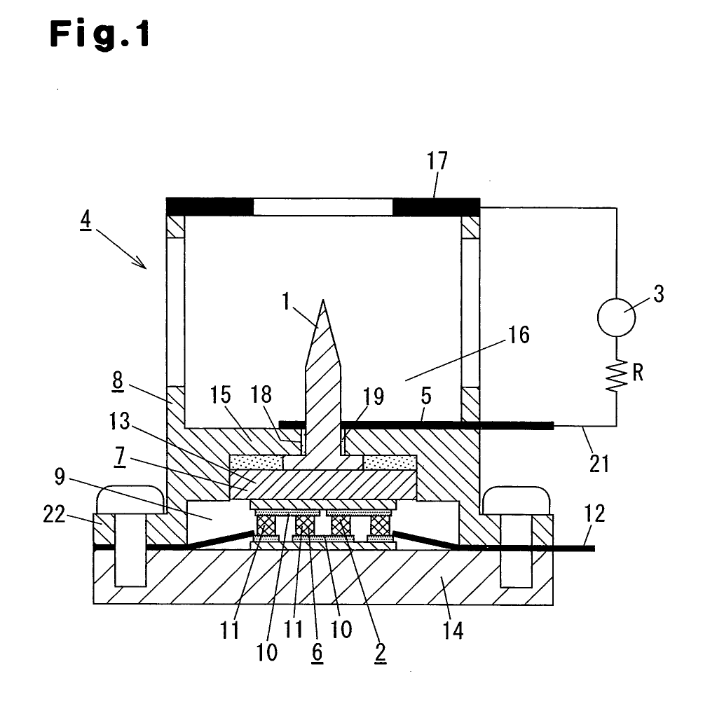

One embodiment of the present invention will now be discussed with reference to the drawings. FIG. 1 is a schematic diagram showing an electrostatic atomization apparatus 4. The electrostatic atomization apparatus 4 includes a discharge electrode 1, a liquid supplying device 2, and a high voltage application device 3. The liquid supplying device 2 supplies the discharge electrode 1 with liquid. The high voltage application device 3 applies high voltage to the liquid supplied to the discharge electrode 1.

In the embodiment shown in FIG. 1, the liquid supplying device 2 is, for example, a cooling device. The cooling device cools the discharge electrode to condense the moisture in air on the discharge electrode 1. This supplies the discharge electrode 1 with water. The cooling device, or the liquid supplying device 2, includes, for example, a Peltier unit 6.

The Peltier unit 6 includes two Peltier circuit boards 10 and a plurality of thermoelectric elements 11 arranged between the two Peltier circuit boards 10. Each Peltier circuit board 10 includes an insulative plate and a circuit section located on one side of the insulative plate. The insulative plate is formed from alumina or aluminum nitride, which have high thermal conductance. The thermoelectric elements 11 are held between the circuit sections of the two Peltier circuit boards 10 that face toward each other to electrically couple between the adjacent thermoelectric elements 11. When current flows through a Peltier input line 12 to the thermoelectric elements 11, heat is conveyed from one of the Peltier circuit boards 10 to the other one of the Peltier circuit boards 10.

In the embodiment of FIG. 1, the Peltier circuit board 10 on one side of the Peltier unit 6 serves as a cooling side. A cooling insulative plate 13 is coupled to an outer side of the cooling Peltier circuit board 10. The cooling insulative plate 13 has high thermal conductance and withstands high voltages, and is formed from alumina, aluminum nitride, or the like. The insulative plate of the cooling Peltier circuit board 10 and the cooling insulative plate 13 form a cooling portion 7. The other Peltier circuit board 10 serves as a heat radiation side. A heat radiation portion 14, which has high thermal conductance and is formed from metal such as aluminum, is coupled to an outer side of the heat radiating side Peltier circuit board 10.

A housing 8 is formed from an insulative material such as polybutylene terephthalate (PBT) resin, polycarbonate, or polyphenylene sulfide (PPS) resin. The housing 8 includes a tubular wall having openings (right side and left side in FIG. 1). Further, the housing 8 includes an intermediate portion in which a partition 15 partitions the housing 8 into an accommodation chamber 9 and a discharge chamber 16. The accommodation chamber 9 has an open rear side (lower side as viewed in FIG. 1) and a flange 22, which is coupled to the heat radiation portion 14 and extends from the entire circumference of the open rear end. The discharge chamber 16 has an open front side (upper side as viewed in FIG. 1). A ring-shaped opposing electrode 17 is arranged on the open front end.

The Peltier unit 6 is accommodated in the accommodation chamber 9 with the heat radiation portion 14 located outside the accommodation chamber 9. In this state, the peripheral portion of the heat radiation portion 14 is fixed to the flange 22 to accommodate the Peltier unit 6 in the housing 8.

When the housing 8 is coupled to the Peltier unit 6, the discharge electrode 1 is fitted into a hole 18 extending through the partition 15. The discharge electrode 1 includes a basal portion (large diameter portion) arranged in the accommodation chamber 9. The remaining part of the discharge electrode 1 is arranged in the discharge chamber 16. The basal portion (large diameter portion) of the discharge electrode 1 is held between the partition 15 of the housing 8 and the cooling portion 7 of the Peltier unit 6. This holds the discharge electrode 1 in a state pressed against the cooling portion 7 of the Peltier unit 6. The cooling portion 7 of the Peltier unit 6 and the basal portion of the discharge electrode 1 may be adhered together by an adhesive agent having superior thermal conductance. The hole 18, into which the discharge electrode 1 is fitted, may be sealed by a seal 19.

The discharge electrode 1, which is coupled to the cooling portion 7 of the Peltier unit 6, is generally rod-shaped and formed from a material having high thermal conductance and electrical conductance. The discharge electrode 1 produces condensed water when cooled by the Peltier unit 6. The ring-shaped opposing electrode 17 has a center lying along an extension of the distal end of the discharge electrode 1.

As shown in FIG. 1, a high voltage application plate 5, which extends through the housing 8, is arranged in the discharge chamber 16. The high voltage application plate 5 has a first end portion coupled to the discharge electrode 1 near the basal portion and a second end portion extending out of the housing 8. The first end portion of the high voltage application plate 5 is located in the discharge chamber 16. The second end portion of the high voltage application plate 5 is coupled to the high voltage application device 3 by a high voltage lead line 21. The high voltage application device 3 applies high voltage to the discharge electrode 1. In the embodiment shown in FIG. 1, the opposing electrode 17 is also coupled to the high voltage application device 3. The high voltage application device 3 applies high voltage between the discharge electrode 1 and the opposing electrode 17.

Further, in the embodiment of FIG. 1, a resistor R of 40 MΩ to 150 MΩ is coupled in series to the circuit that applies high voltage to the discharge electrode 1. The resistor R serves as a discharge optimization unit. Here, the “circuit that applies high voltage to the discharge electrode 1” refers to the high voltage application device 3 in the example of FIG. 1. In this case, the resistor R is arranged on the lead line 21, which couples the high voltage application device 3 and the high voltage application plate 5. That is, the resistor R is arranged in a path used to apply high voltage to the discharge electrode 1. The resistor R may be two or more resistors that are electrically coupled in series to one another.

In the electrostatic atomization apparatus 4, when current flows to the thermoelectric elements 11, each thermoelectric element 11 conveys heat in the same direction (upper side to lower side as viewed in FIG. 1). This cools the cooling portion 7 of the Peltier unit 6, which, in turn, cools the discharge electrode 1 coupled to the cooling portion 7. As a result, the air around the discharge electrode 1 is cooled, and the moisture in the air is condensed and liquefied. This forms condensed water on the distal portion of the discharge electrode 1.

A control unit (not shown) controls the application of high voltage to the high voltage application device 3 and the flow of current to the Peltier unit 6.

In a state in which the discharge electrode 1 is cooled and condensed water is formed on the distal portion of the discharge electrode 1, the high voltage application device 3 applies high voltage to the water on the distal portion of the discharge electrode 1. The high voltage charges the water on the distal portion of the discharge electrode 1, and Coulomb force acts on the charged water. As a result, the surface level of the water locally rises and forms a conical shape (Taylor cone). The concentration of charge at the distal end of the conical water increases the charge density at the distal end. The repulsive force of the high density charge fragments and scatters the water (Rayleigh fission). Electrostatic atomization is performed in this manner to generate charged micro-particle water (negative ion mist) of nanometer size including radicals.

As mentioned above, the resistor R of 40 MΩ to 150 MΩ is coupled in series to the circuit that applies high voltage to the discharge electrode 1, or the high voltage application device 3. As shown below, table 1 lists the acoustic pressure, peak current value of the discharge electrode 1, frequency (Trichel pulse frequency), and frequency variation (Trichel pulse frequency variation), which were measured when changing the value of the resistor R. In table 1, the value of the resistor R is represented as the resistance sum of a discharge electrode side resistor and a ground side resistor, which are electrically coupled in series.

TABLE 1

| | Discharge | | | Trichel Pulse | | |
|---|---|---|---|---|---|---|
| | Electrode Side | GND Side | Acoustic | Peak | | |
| Sample | Resistance | Resistance | Pressure | Current | Frequency | Frequency |
| No. | MΩ | MΩ | dB(A) | Value μA | Hz | Variation |
| 1 | 75 | 13 | 43.5 | 203.2 | 1209 | 289 |
| 2 | 3 | 13 | 42.6 | 183.3 | 1151 | 100 |
| 3 | 3 | 0 | 41.3 | 175.6 | 1152 | 126 |
| 4 | 75 | 0 | 42.4 | 208.6 | 1217 | 238 |
| 5 | 13 | 75 | 44.0 | 202.6 | 1251 | 221 |

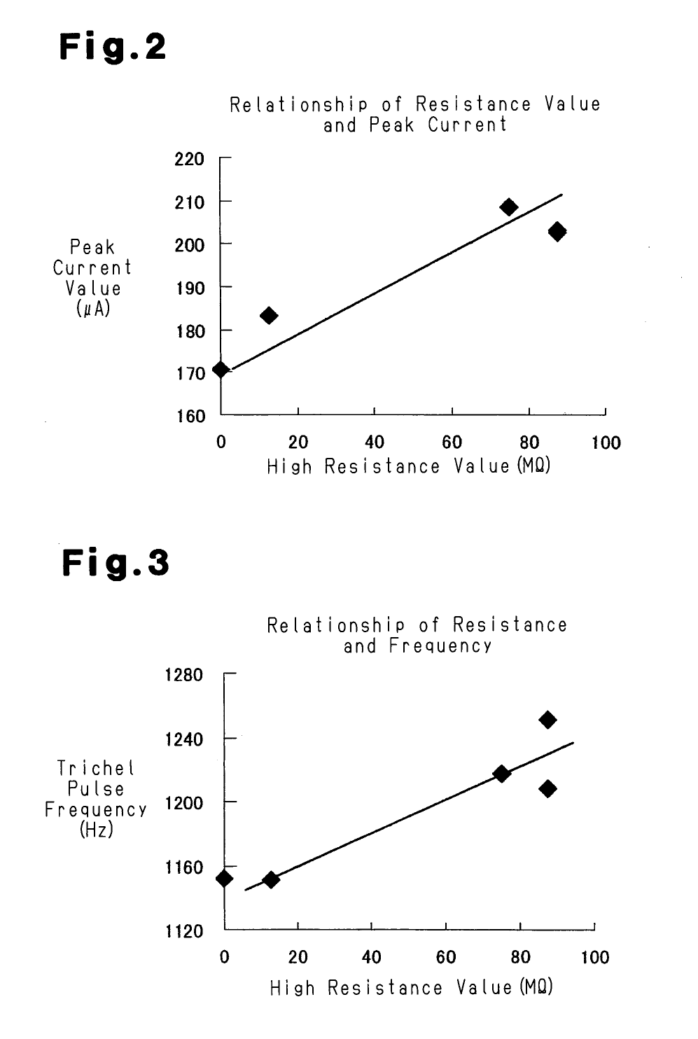

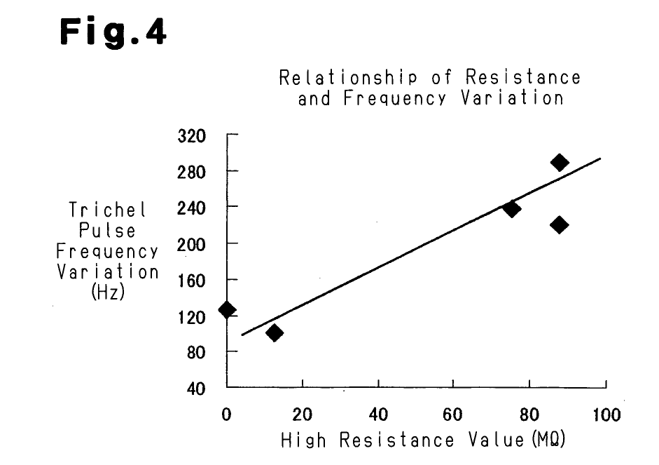

FIG. 2 is a graph showing the relationship of the resistance value and the peak current value based on the measurement results of table 1. FIG. 3 is a graph showing the relationship of the resistance value and the frequency (Trichel pulse frequency) based on the measurement result of table 1. Further, FIG. 4 is a graph showing the relationship of the resistance value and the frequency variation (Trichel pulse variation) based on the measurement result of table 1.

As apparent from FIGS. 2, 3, and 4, when the resistance value is increased, the peak current value, the Trichel pulse frequency, and the Trichel pulse frequency variation increases. Further, as apparent from table 1, when the resistance value is increased, the acoustic pressure increases, and the Trichel pulse frequency characteristics become broad.

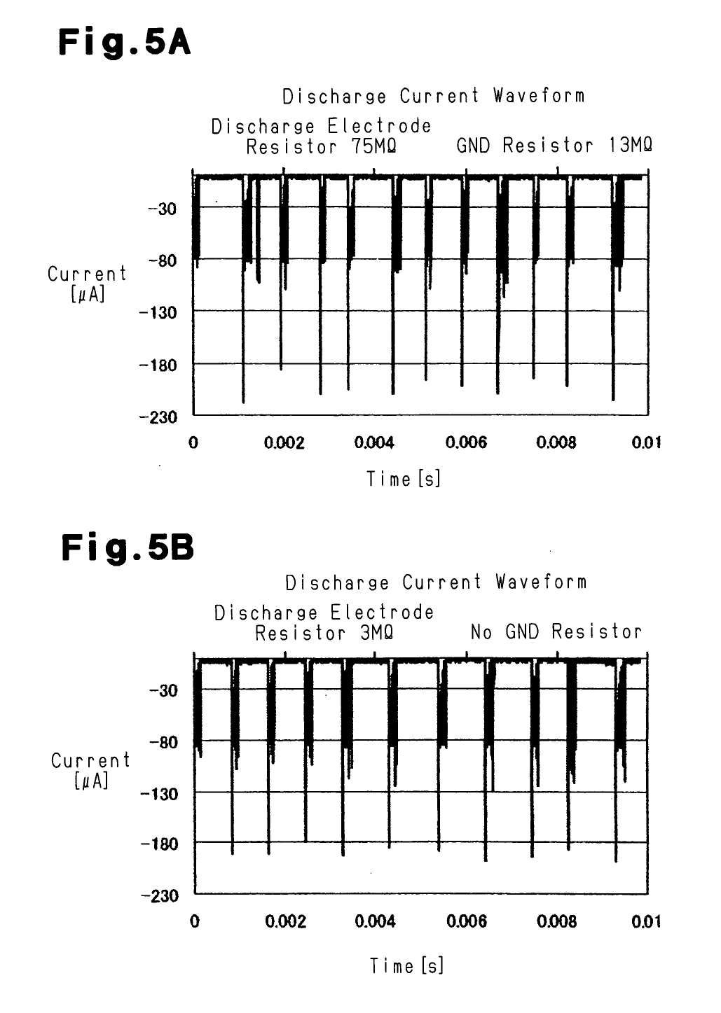

FIGS. 5A and 5B respectively show the discharge current waveforms of samples 1 and 3, which are included in table 1. More specifically, FIG. 5A shows the discharge current waveform when the resistor R, which is coupled in series to the high voltage application device 3, includes a 75 MΩ discharge electrode side resistor and a 13 MΩ ground side resistor. FIG. 5B shows the discharge current waveform when the resistor R coupled in series to the high voltage application device 3 includes only a 3 MΩ discharge electrode side resistor (no ground side resistor). As apparent from FIGS. 5A and 5B, as the resistance value of the resistor R coupled in series to the high voltage application device 3 increases, the discharge current waveform becomes acyclic.

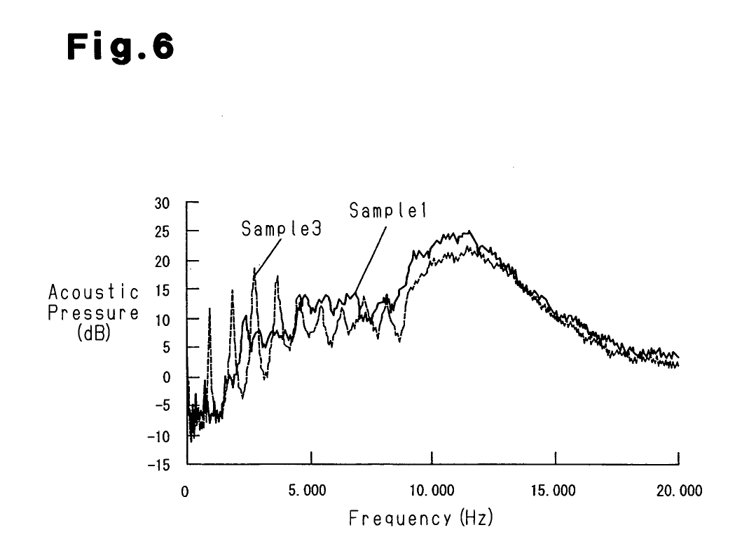

FIG. 6 is a graph showing the frequency characteristics of acoustic pressure for the resistance values of samples 1 and 3. As shown in FIG. 6, when the resistance value is small (sample 3), noise increases at a specific frequency. When the resistance value is high (sample 1), noise decreases at the specific frequency.

In relation with the graph of FIG. 4, it is believed that an increase in the resistance value of the resistor R, which is coupled in series to the high voltage application device 3, increases the Trichel pulse frequency variation for the reasons described below.

When the resistor R is coupled in series to the high voltage application device 3, an increase in the resistance value of the resistor R shortens the time for accumulating the charge (charging time) required for discharging. Accordingly, by increasing the resistance value of the resistor R to shorten the charging time, the charge required for discharging accumulates and enables discharging even when the Taylor cone has not grown to a certain length (the distance from the distal end of the Taylor cone to the opposing electrode 17 is long). That is, electrostatic atomization resulting from discharging is enabled. In other words, due to the short charging time, when the Taylor cone is in a stage of growth, the charge potential may reach a potential that causes discharging at the distal end of the Taylor cone so that Rayleigh fission occurs. Accordingly, even when the Taylor cone is still growing, electrostatic atomization occurs when the charge potential reaches a state enabling discharging. In this manner, when charge required for discharging is accumulated, discharging occurs at any stage of growth of the Taylor cone. Thus, the Taylor cones vary in size when discharging starts, and the Taylor cones act in an acyclic manner. That is, the discharge current waveform is acyclic when electrostatic atomization occurs.

In this manner, acyclic electrostatic atomization reduces noise at a specific frequency. This reduces noise that is uncomfortable for a person.

Noise produced at a certain frequency when electrostatic atomization occurs is reduced thereby decreasing noise that is uncomfortable to a person as long as the Trichel pulse frequency variation is 0.17 kHz or greater. Referring to FIG. 4, the resistance value of the resistor R coupled in series to the high voltage application device 3 must be 40 MΩ or greater for the Trichel pulse frequency variation to be 0.17 kHz or greater.

When the resistance value of the resistor R coupled in series to the high voltage application device is increased thereby shortening the charging time, blank discharging may occur when the Taylor cone has still not grown to a level enabling electrostatic atomization to occur. On the other hand, when discharging occurs in a state in which the Taylor cone has grown to be large, the force pulling the Taylor cone is too strong. This may instantaneously suspend discharging and hinder continuous generation of the charged micro-particle water.

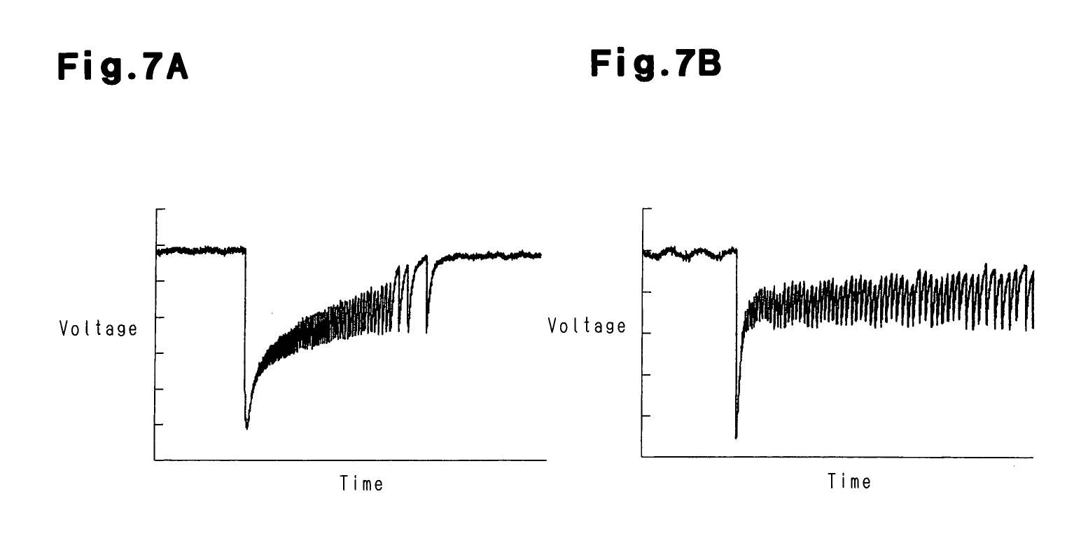

FIG. 7A shows changes in the voltage at the discharge electrode 1 when coupling a 75 MΩ resistor R. FIG. 7B shows changes in the voltage at the discharge electrode 1 when coupling a 170 MΩ resistor R. In FIGS. 7A and 7B, the vertical axis represents voltage, and the horizontal axis represents time.

As apparent from FIG. 7, when coupling a 170 MO resistor R, the force that pulls the Taylor cone is too strong and discharging is instantaneously suspended.

In this manner, the resistor R that instantaneously suspends discharging is 150 MΩ or greater.

Accordingly, in the preferred embodiment, in order for the potential at the discharge electrode 1 to be such that electrostatic atomization is performed in an acyclic manner without suspending discharging, a resistor R of 40 MO to 150 MΩ is coupled in series to the high voltage application device 3 so that the Trichel pulse frequency variation is 0.17 kHz or greater when electrostatic atomization occurs. In this structure, electrostatic atomization is acyclic. This reduces noise at a specific frequency and decreases uncomfortable noise. Further, the charging time is set at a suitable value. This reduces power consumption. Further, the elimination of Taylor cones (i.e., the stopping of discharging) is avoided. This continuously generates charged micro-particle water.

In the electrostatic atomization apparatus 4 of the embodiment described above, it is obvious that the opposed electrode 17 may be eliminated.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

1. An electrostatic atomization apparatus comprising:
a discharge electrode;
a liquid supplying device that supplies liquid to the discharge electrode;
a high voltage application device that applies high voltage to the discharge electrode so that the liquid supplied to the discharge electrode undergoes electrostatic atomization; and
a discharge optimization unit electrically coupled to the high voltage application device in order for potential at the discharge electrode to be such that the electrostatic atomization occurs in an acyclic manner without stopping discharging, wherein the discharge optimization unit provides the discharge electrode with the potential for maintaining a Trichel pulse frequency variation to be 0.17 kHz or greater.

2. The electrostatic atomization apparatus according to claim 1, wherein the discharge optimization unit includes a resistor coupled in series to the high voltage application device, and the resistor has a resistance value of 40 MΩ to 150 MΩ so that the Trichel pulse frequency variation is 0.17 kHz or greater when the electrostatic atomization occurs.

3. The electrostatic atomization apparatus according to claim 1, wherein the discharge optimization unit is coupled in series between the discharge electrode and the high voltage application device.
